(19) United States
(12) Patent Application Publication
(10) Pub. No.: US 2007/0219973 A1
(43) Pub. Date: Sep. 20, 2007

(54) Dynamic statement processing in database systems

(75) Inventors: Baoqiu Cui, San Jose, CA (US); You-Chin Fuh, San Jose, CA (US); Jeff M. Sullivan, Cave Creek, AZ (US); Yoichi Tsuji, San Jose, CA (US); Li Xia, San Jose, CA (US)

Correspondence Address: SAWYER LAW GROUP LLP, P.O. BOX 51418, PALO ALTO, CA, 94303, US

(73) Assignee: International Business Machines Corporation, Armonk, NY (US)

(21) Appl. No.: 11/377,328

(22) Filed: Mar. 15, 2006

(51) Int. Cl. G06F 17/30

(52) U.S. Cl. 707/4

(57) ABSTRACT

A method, computer program product, and system for processing dynamic statements in a database system are provided. The method, computer program product, and system provide for calculating a first set of characteristics associated with a dynamic statement when the dynamic statement matches one of a plurality of dynamic statements previously processed by the system, comparing the first set of characteristics associated with the dynamic statement to a second set of characteristics associated with one of one or more access paths generated for the one previously processed dynamic statement, and utilizing the one access path to execute the dynamic statement when the comparison of the first set of characteristics to the second set of characteristics satisfies one or more predetermined criteria.

### FIELD OF THE INVENTION

The present invention relates generally to database systems. More particularly, the present invention is directed to dynamic statement processing in database systems.

### BACKGROUND OF THE INVENTION

Data in database systems are typically accessed using commands submitted in the form of SQL (Structured Query Language) statements. These SQL statements may be submitted directly to the database system or via an independent software application working in conjunction with the database system.

When an independent software application is used, SQL statements are frequently embedded within the application. The SQL statements that are embedded within application programs are conventionally static in nature, i.e., hard-coded such that only the values of host-variables in predicates can change during execution of the programs.

In order to increase flexibility, programmers have begun to utilize dynamic statements in applications. Dynamic statements, unlike static statements, have the ability to change the columns, tables, and predicates referenced during execution. Additionally, dynamic statements are not embedded within a program like static statements, but are instead stored in character strings that can be entered into or built by the program at run-time.

However, because dynamic statements can change columns, tables, and predicates referenced at run-time, each time a dynamic statement is submitted, the database system has to prepare the dynamic statement for execution, including optimizing the statement to find the best access path to execute the dynamic statement. This can adversely affect system performance.

To address issues relating to performance of dynamic statements, some database systems cache previously prepared dynamic statements and the access path generated for each of those statements. These database systems, however, will utilize a cached access path only if the corresponding previously prepared dynamic statement is identical to a dynamic statement currently being processed. Hence, even if the two dynamic statements only differ, for example, in spacing of characters, such that the generation of a different access path is not necessary, the dynamic statement currently being processed will still be separately prepared, which wastes system resources.

Moreover, when an identical previously prepared dynamic statement is found, the access path generated for that statement is automatically utilized, even though that access path may not be appropriate for the dynamic statement currently being processed. For instance, if the previously prepared dynamic statement contained a parameter marker, the access path generated for that statement may not be optimal for all possible literals that could be substituted for the parameter marker during execution. Utilization of a less than optimal access path can lead to performance disasters.

Accordingly, there is a need for dynamic statement processing that better utilizes previously prepared dynamic statements and is capable of determining whether an access path generated for a previously prepared dynamic statement is optimal for a dynamic statement currently being processed. The present invention addresses such a need.

### SUMMARY OF THE INVENTION

A method, computer program product, and system for processing dynamic statements in a database system are provided. The method, computer program product, and system provide for calculating a first set of characteristics associated with a dynamic statement when the dynamic statement matches one of a plurality of dynamic statements previously processed by the system, comparing the first set of characteristics associated with the dynamic statement to a second set of characteristics associated with one of one or more access paths generated for the one previously processed dynamic statement, and utilizing the one access path generated for the one previously processed dynamic statement to execute the dynamic statement when the comparison of the first set of characteristics to the second set of characteristics satisfies one or more predetermined criteria.

### BRIEF DESCRIPTION OF THE DRAWINGS

FIG. 1 is a process flow of a method for processing dynamic statements in a database system according to an aspect of the invention.

FIG. 2 illustrates a system for processing dynamic statements in accordance with one implementation of the invention.

FIG. 3 depicts a flowchart of a method for processing dynamic statements in a database system according to an embodiment of the invention.

FIG. 4 shows a system for processing dynamic statements in accordance with another aspect of the invention.

FIG. 5 is a block diagram of a data processing system with which embodiments of the present invention can be implemented.

### DETAILED DESCRIPTION

The present invention relates generally to database systems and more particularly to dynamic statement processing in database systems. The following description is presented to enable one of ordinary skill in the art to make and use the invention and is provided in the context of a patent application and its requirements. Various modifications to the preferred implementations and the generic principles and features described herein will be readily apparent to those skilled in the art. Thus, the present invention is not intended to be limited to the implementations shown, but is to be accorded the widest scope consistent with the principles and features described herein.

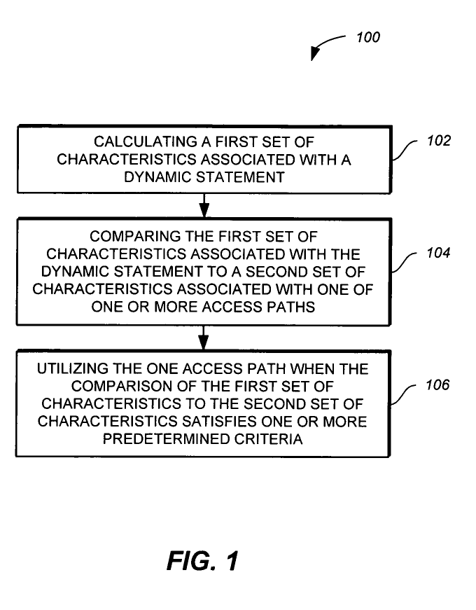

FIG. 1 depicts a process 100 for processing dynamic statements in a database system according to an aspect of the invention. At 102, a first set of characteristics associated with a dynamic statement is calculated when the dynamic statement matches one of a plurality of dynamic statements previously processed by the database system. In an embodiment, the first set of characteristics includes an overall filtering associated with each of one or more tables referenced by one or more predicates in the dynamic statement and a filtering and cost associated with each of one or more indexes for the one or more tables referenced by the one or more predicates in the dynamic statement. In another embodiment, the first set of characteristics also includes a filter factor associated with one or more parametric predicates in the dynamic statement.

The first set of characteristics associated with the dynamic statement is then compared to a second set of characteristics associated with one of one or more access paths generated for the one previously processed dynamic statement (104). In an implementation, the second set of characteristics associated with the one access path includes an overall filtering associated with a leading table used by the one access path and a filtering and cost associated with each of one or more indexes used by the one access path. At 106, the one access path generated for the one previously processed dynamic statement is utilized to execute the dynamic statement when the comparison of the first set of characteristics to the second set of characteristics satisfies one or more predetermined criteria (106).

In one embodiment, the one or more predetermined criteria includes a first criterion requiring a leading table used by the one access path to provide filtering that is better than or within a first predetermined range (e.g., 1-5%) of filtering provided by each of one or more alternative leading tables, a second criterion requiring each of one or more indexes used by the one access path to provide filtering that is better than or within a second predetermined range (e.g., 1-3%) of filtering provided by each of one or more alternative indexes, and/or a third criterion requiring each of the one or more indexes used by the one access path to have an associated cost that is less than or within a third predetermined range (e.g., 1-10%) of a cost associated with each of the one or more alternative indexes. The first predetermined range and the second predetermined range may be the same in some embodiments. Additionally, the third predetermined range may be the same as the first predetermined range and/or the second predetermined range.

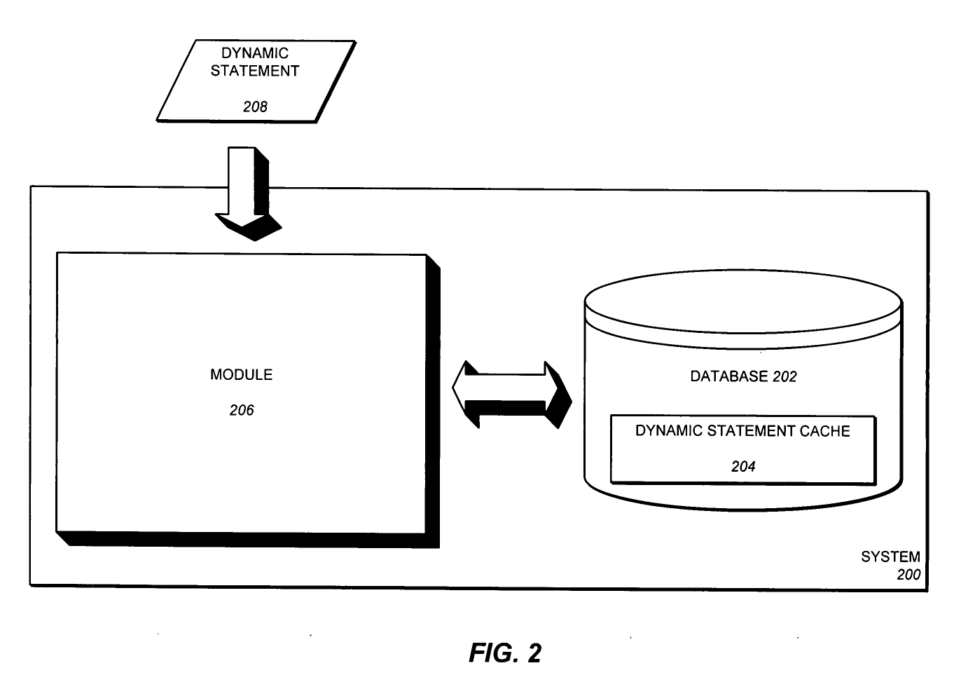

Shown in FIG. 2 is a system 200 for processing dynamic statements in accordance with one aspect of the invention. System 200 comprises a database 202 with a dynamic statement cache 204 and a module 206. Although system 200 is shown with only one database and one module in the implementation, system 200 may include additional databases and modules in other implementations. In addition, it is not necessary that all databases in system 200 include a dynamic statement cache.

In FIG. 2, a dynamic statement 208 is received by system 200 for processing. Dynamic statement 208 may be submitted by a client application (not shown) connected to system 200 via a network (not shown). System 200 will determine whether any previously processed dynamic statements that are cached in dynamic statement cache 204 matches dynamic statement 208. If none of the previously processed dynamic statements match, system 200 will proceed to generate an access path for dynamic statement 208 and then utilize that access path to execute dynamic statement 208. Determination of a match, generation of an access path, and utilization of that access path may occur within module 206 of system 200 or within one or more other modules (not shown) in system 200.

However, if a match is found, module 206 will calculate a first set of characteristics associated with dynamic statement 208. In one implementation, the first set of characteristics is calculated based on one or more statistics collected for the matching previously processed dynamic statement and stored in system 200. The one or more statistics may be stored in database 202 or one or more other databases (not shown) in system 200.

Module 206 will also calculate a second set of characteristics associated with an access path that has already been generated for the matching previously processed dynamic statement. That access path may be stored in dynamic statement cache 204, in a separate area of database 202, or in another database (not shown) in system 200. The second set of characteristics may also be calculated based on the one or more statistics collected for the matching previously processed dynamic statement. In some embodiments, the one or more statistics are stored as a part of a generated access path. Additionally, the second set of characteristics may be calculated before or at the same time the first set of characteristics are calculated.

The first set of characteristics will then be compared with the second set of characteristics by module 206 to determine whether one or more predefined criteria are satisfied. If the one or more predefined criteria are satisfied, the access path will be utilized to process dynamic statement 208. However, if the one or more predefined criteria are violated, system 200 will determine if another access path has also been generated for the matching previously processed dynamic statement on.

If another access path has also been generated for the matching previously processed dynamic statement, characteristics associated with that access path will be calculated and evaluated to determine whether the one or more predefined criteria are satisfied. Module 206 in system 200 will continue to evaluate access paths that have been generated for the matching previously processed dynamic statement until a suitable access path is found for dynamic statement 208 or until all of the access paths have been evaluated. If no suitable access path is found after evaluating all access paths that have been generated for the matching previously processed dynamic statement, a new access path will be generated for dynamic statement 208.

The number of access paths cached for each previously processed dynamic statement may be limited. For example, when a new access path is generated for a previously processed dynamic statement, the database system can determine if any of the existing access paths have been stored beyond a threshold time or automatically prune the least frequently used access path to make room for the new access path.

To illustrate one implementation of the invention, suppose the following sample dynamic statement [1] written in pseudo-SQL (Structured Query Language) code is submitted to a database system for processing:

| SELECT Sales.Year, Calendar.Month, | |
|---|---|
| sum(Sales.UnitPrice * Sales.Quantity) | |
| FROM Sales, Calendar | |
| WHERE Sales.CID = Calendar.ID and | |
| Sales.Quantity > ? | [1] |

Dynamic statement [1] seeks to retrieve the rows from tables “Sales” and “Calendar” in the database system that satisfy two predicates “Sales.CID=Calendar.ID” and “Sales.Quantity>?”. The second predicate “Sales.Quantity>?” is sometimes referred to as a parametric predicate because it includes a parameter marker “?”.

In the example, the “Sales” table includes 1 million rows and has an index “Sales_Quant” on the “Quantity” column and an index “Sales_ID” on the “CID” column. The “Calendar” table includes 1,000 rows and has an index “Calendar_ID” on the “ID” column. It is known that if the parameter marker is replaced with a literal value “1,” all rows of the “Sales” table and all rows of the “Calendar” table will satisfy the two predicates. However, if the parameter marker is replaced with a literal value “10,000,” only 100 rows of the “Sales” table will be retrieved. And, if the parameter marker is replaced with a literal value “5,000,” only 200 rows of the “Sales” table will qualify.

Assume, for instance, that when dynamic statement [1] is first received for processing, the parameter marker has been replaced with the literal value “1.” Since dynamic statement [1] has never been processed before, an access path will be generated using the “Calendar” table as the leading table (e.g., the “Calendar” table nest-loop-joining the “Sales” table), the “Calendar_ID” index for the “Calendar” table, and the “Sales_ID” index for the “Sales” table. Dynamic statement [1] will then be executed using the access path, which will be stored in the database system as “access path 1” along with one or more statistics collected during its generation for later use.

When dynamic statement [1] is submitted to the database system again for processing, assume that the literal value remains “1.” In this instance, the database system will realize that it has processed the same statement before and locate “access path 1,” which has already been generated for the statement. The database system will then determine whether “access path 1” is appropriate for the current execution of dynamic statement [1].

To determine whether “access path 1” is optimal, an overall filtering associated with the “Calendar” table and the “Sales” table will be calculated using the one or more collected statistics stored in the database system as they are both referenced by the predicates in dynamic statement [1]. The overall filtering for the two tables are the same (i.e., 1.0 or 100%) because all of the rows in each table will satisfy the predicates in the statement. Since the “Calendar” table, which is used by “access path 1” as the leading table, is smaller (i.e., it only has 1,000 rows compared to the “Sales” table's 1 million rows), a first criterion requiring the leading table used by the access path to provide filtering that is better than or within a predetermined range of filtering provided by each alternative leading table is satisfied. The predetermined range in the example is 1-5%. Alternative leading tables include any other table referenced by one or more predicates in a dynamic statement.

A filtering and cost associated with the “Calendar_ID” index, the “Sales_ID” index, and the “Sales_Quant” index will also be calculated using the one or more collected statistics stored in the database system because they can be used for the “Calendar” and “Sales” tables, which are both referenced by the predicates in dynamic statement [1]. Since there is no alternative index to the “Calendar_ID” index used by “access path 1,” neither a second criterion requiring each index used by the access path to provide filtering that is better than or within the predetermined range (i.e., 1-5% in the example) of filtering provided by each alternative index, nor a third criterion requiring each index used by the access path to have an associated cost that is less than or within the predetermined range of a cost associated with each alternative index are violated with respect to the “Calendar_ID” index.

In addition, using the “Sales_Quant” index would be identical to using a table scan because with a literal value of “1,” none of the rows of the “Sales” table are filtered. As such, the “Sales_ID” index used by “access path 1” still provides the best performance and the second and third criterions are therefore satisfied with respect to the “Sales_ID” index. Hence, the second execution of dynamic statement [1] will proceed with “access path 1.”

Dynamic statement [1] is then received by the database system for processing a third time. Assume that the literal value in place of the parameter marker is now “10,000.” The database system will again realize that “access path 1” has already been generated for this statement on a previous occasion and determine whether it is appropriate for the third execution of dynamic statement [1].

The overall filtering of the “Calendar” table and the “Sales” table will be calculated in light of the current literal value. In this instance, although the overall filtering for the “Calendar” table remains 1.0 or 100%, the overall filtering for the “Sales” table has changed drastically to 0.0001 or 0.01% since only 100 of the 1 million rows in the “Sales” table will satisfy the parametric predicate in the statement. As a result, the first criterion is violated because the leading table used by “access path 1” (i.e., the “Calendar” table) does not provide filtering that is better than or within the predetermined range of filtering provided by each of one or more alternative leading tables (i.e., the “Sales” table).

Since no other access paths have been created for dynamic statement [1], a new “access path 2” will be generated using the “Sales” table as the leading table (e.g., the “Sales” table nest-loop-joining the “Calendar” table), the “Sales_Quant” index, and the “Calendar_ID” index. The third execution of dynamic statement [1] will then proceed with “access path 2,” which will also be stored in the database system. In some embodiments, one or more statistics collected during generation of “access path 2” may be used to replace the one or more stored statistics collected during generation of “access path 1.”

Assume dynamic statement [1] is submitted for processing a fourth time with a literal value of “5,000.” The database system will recognize that dynamic statement [1] has been processed before and that two access paths—“access path 1” and “access path 2”—have already been created for the statement. Hence, “access path 1” and “access path 2” will be evaluated to determine whether one of them is optimal for the fourth execution of dynamic statement [1].

As with before, the overall filtering of the “Calendar” table and the “Sales” table will be calculated in light of the current literal value of “5,000.” In this instance, the overall filtering for the “Calendar” table is 1.0 or 100% and the overall filtering for the “Sales” table is 0.0002 or 0.02% as all of the rows in the “Calendar” table and 200 of the rows in the “Sales” table will satisfy the predicates in the statement.

With respect to “access path 1,” the first criterion will be violated since the leading table used by “access path 1” (i.e., the “Calendar” table) does not provide filtering that is better than or within the predetermined range of filtering provided by each of one or more alternative leading tables (i.e., the “Sales” table). Therefore, “access path 1” will not be used to execute dynamic statement [1].

On the other hand, the first criterion is satisfied with respect to “access path 2” because the leading table used by “access path 2” (i.e., the “Sales” table) provides better filtering than each of one or more alternative leading tables (i.e., the “Calendar” table). Hence, the filtering and cost associated with the “Sales_Quant” index and the “Sales_ID” index will be calculated to determine whether the second and third criterions are satisfied. In this implementation, the filtering and cost associated with the “Calendar_ID” index is not calculated as it has no alternative indexes.

The “Sales_Quant” index in this instance provides 0.0002 or 0.02% filtering, whereas the “Sales_ID” index provides no filtering. Consequently, the second and third criterions are also satisfied since the index used by “access path 2” (i.e., the “Sales_Quant” index) provides better filtering and costs less than each of one or more alternative indexes (i.e., the “Sales_ID” index). As a result, database system will proceed with execution of dynamic statement [1] using “access path 2.” By using an already generated access path only when it is determined to be optimal for the current execution of a dynamic statement provides protection against performance disasters.

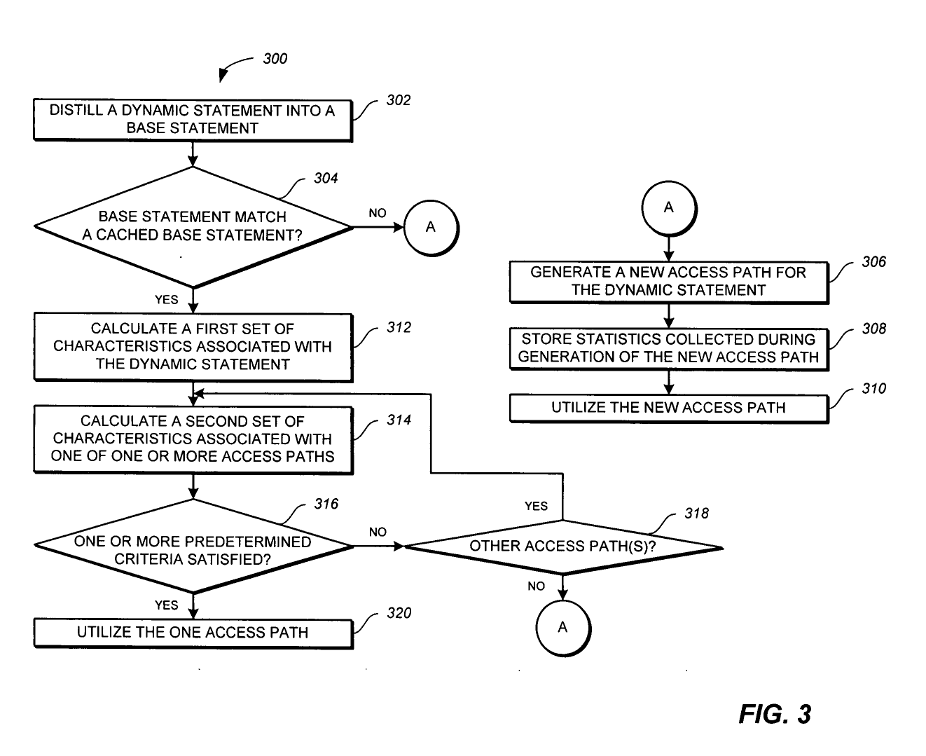

FIG. 3 illustrates a process 300 for processing dynamic statements in a database system according to another aspect of the invention. At 302, a dynamic statement is distilled into a base statement. A base statement is a dynamic statement with all literals representing non-column expressions in one or more predicates of the dynamic statement parsed out. In one embodiment, the parsed out literals are replaced with parameter markers. Additionally, base statements may be stored in the database system's global memory or address space. Below are examples of dynamic statements with literals written in pseudo-SQL:

| | |
|---|---|
| SELECT Table.Name, Table.Dept | |
| FROM Table | [2] |
| WHERE Table.Name = ‘JEFF%’ | |
| SELECT Table.Name, Table.Dept | |
| FROM Table | [3] |
| WHERE Table.Name = ‘JEFF% ’ | |
| SELECT Table.Name, Table.Dept | |
| FROM Table | [4] |
| WHERE Table.Name = ‘RON%’ | |

When dynamic statements [2], [3], and [4] are distilled, they will be distilled into the same base statement, shown below as base statement [5], since literals ‘JEFF %’, ‘JEFF %’, and ‘RON %’ will be removed. In some embodiments, the removed literals are stored along with the base statements in, for instance, the global memory or address space of the database system.

| | |
|---|---|
| SELECT Table.Name, Table.Dept | |
| FROM Table | [5] |
| WHERE Table.Name = ? | |

Hence, where previously dynamic statements [2], [3], and [4] would not have been considered as matching dynamic statements, when they are distilled into the base statement format, it is easy to recognize that they match one another. This allows for better utilization of access paths that have already been generated for dynamic statements previously processed by the database system.

At 304, a determination is made as to whether the base statement matches a cached base statement corresponding to one of a plurality of dynamic statements previously processed by the database system. If no matches are found, a new access path is generated for the dynamic statement (306), statistics collected during generation of the new access path are stored in the database system (308), and the new access path is utilized to execute the dynamic statement (310). In the embodiment, the base statement and the newly generated access path will also be stored in the database system for later use.

When a match is found, a first set of characteristics associated with the dynamic statement is calculated at 312 and a second set of characteristics associated with one of one or more access paths generated for the one previously processed dynamic statement is calculated at 314. The first set of characteristics and the second set of characteristics are then compared and a determination is made as to whether one or more predetermined criteria are satisfied (316).

If the one or more predetermined criteria are not satisfied, a determination is made at 318 as to whether other access paths have also been generated for the one previously processed dynamic statement. If no other access paths exist, the process returns to block 306. However, if other access paths do exist, the process returns to block 314. When the one or more predetermined criteria are satisfied, the one access path is utilized to execute the dynamic statement (320).

For an embodiment where a dynamic statement submitted for processing only includes one or more parameter markers and no literals, the dynamic statement need not be distilled into a base statement and can be directly compared with a cached base statement. Prior to execution of the dynamic statement, one or more literal values will be passed to the database system to replace the one or more parameter markers in the dynamic statement. The one or more literal values will then be used to calculate the first set of characteristics associated with the dynamic statement and to execute the dynamic statement.

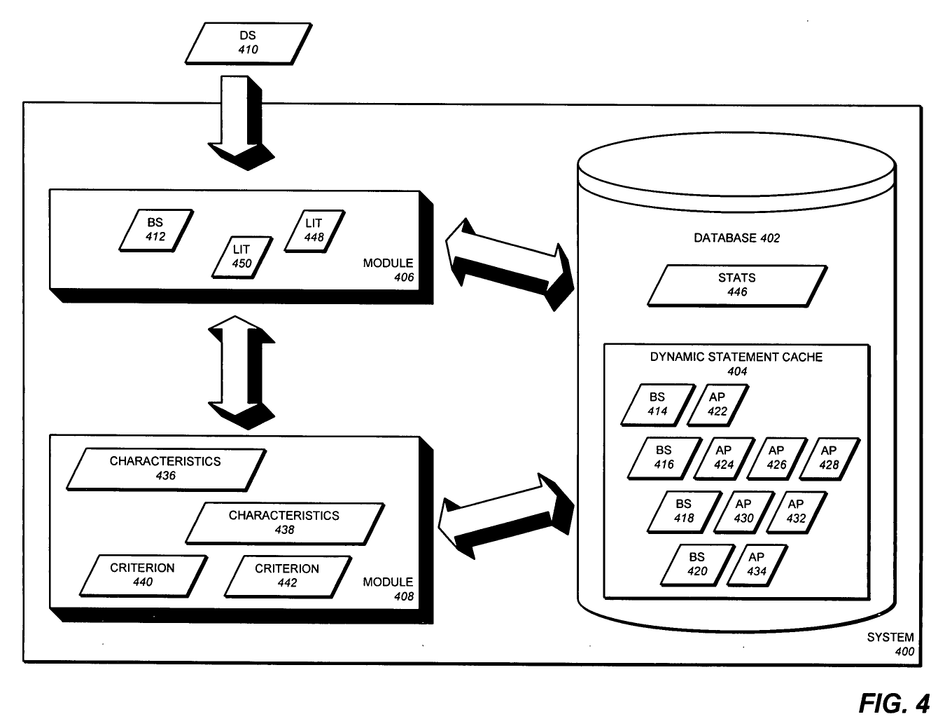

Depicted in FIG. 4 is a system 400 for processing dynamic statements in accordance with an implementation of the invention. System 400 includes a database 402 with a dynamic statement cache 404 and modules 406-408. In the embodiment, four cached base statements 414-420 are stored in dynamic statement cache 404. Each of the cached base statements 414-420 corresponds to a dynamic statement previously processed by system 400. Access paths 422-434, which were generated for the previously processed dynamic statements, are also stored in dynamic statement cache 404.

Statistics 446 collected during generation of access paths 422-434 are stored in database 402. More or less base statements and access paths may be stored in dynamic statement cache 404 in other embodiments. In some implementations, the number of base statements and access paths cached in dynamic statement cache may be limited based on usage, time, quantity, and/or other factors.

In FIG. 4, a dynamic statement 410 is received by system 400 for processing. Module 406 distills dynamic statement 410 into a base statement 412 with two literals 448 and 450. Other embodiments may include more or less literals. Base statement 412 is then compared to cached base statements 414-420 to determine if any of the cached base statements 414-420 match base statement 412. When none of the cached base statements 414-420 match, module 406 will generate a new access path (not shown) and forward the new access path onto module 408 for execution. Base statement 412 and the newly generated access path may be added to dynamic statement cache 404.

On the other hand, if one of the cached base statements 414-420 match, characteristics 436 associated with dynamic statement 410 and characteristics 438 associated with one of the access paths 422-434 corresponding to the previously processed dynamic statement having a matching base statement will be calculated by module 408 based on statistics 446 and in light of literals 448-450 in dynamic statement 410. Characteristics 436 and 438 will then be evaluated to determine whether criterions 440 and 442 are satisfied.

When criterions 440 and 442 are satisfied, the access path evaluated will be used to execute dynamic statement 410 in module 408. On the other hand, if either of criterions 440-442 is violated, a determination will be made as to whether any of the other access paths in dynamic statement cache 404 corresponds to the previously processed dynamic statement having a matching base statement. If there are other corresponding access paths, they will be evaluated in a similar fashion to determine if any is optimal for execution of dynamic statement 410. If there are no other corresponding access paths or if none of the other corresponding access paths are suitable for dynamic statement 410, module 406 will generate a new access path for execution of dynamic statement 10 by module 408.

The invention can take the form of an entirely hardware embodiment, an entirely software embodiment, or an embodiment containing both hardware and software elements. In one aspect, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk—read-only memory (CD-ROM), and compact disk—read/write (CD-R/W).

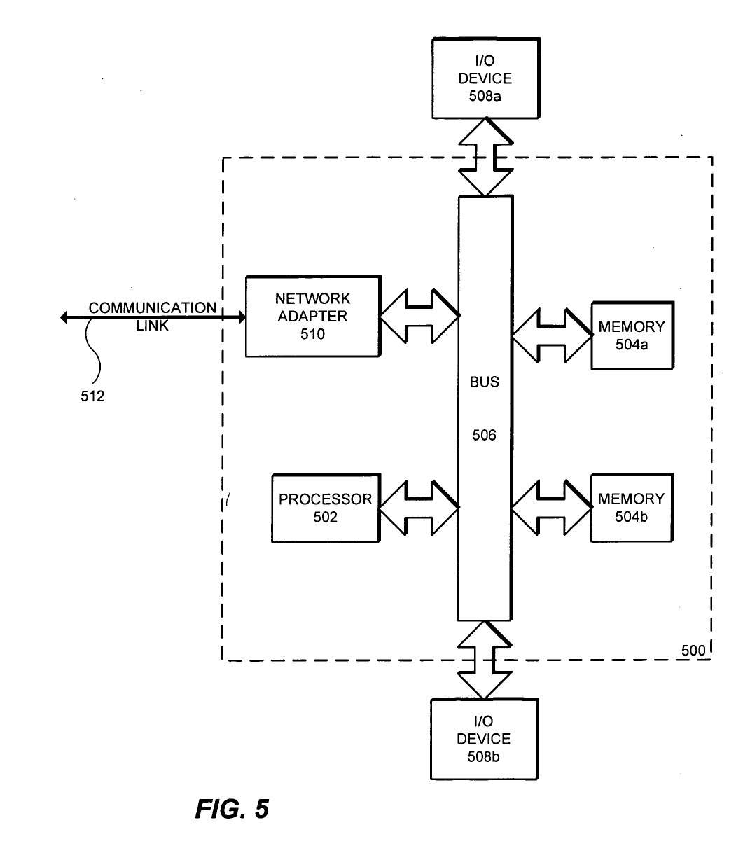

FIG. 5 shows a data processing system 500 suitable for storing and/or executing program code. Data processing system 500 includes a processor 502 coupled to memory elements 504a-b through a system bus 506. In other embodiments, data processing system 500 may include more than one processor and each processor may be coupled directly or indirectly to one or more memory elements through a system bus.

Memory elements 504a-b can include local memory employed during actual execution of the program code, bulk storage, and cache memories that provide temporary storage of at least some program code in order to reduce the number of times the code must be retrieved from bulk storage during execution. As shown, input/output or I/O devices 508a-b (including, but not limited to, keyboards, displays, pointing devices, etc.) are coupled to data processing system 500. I/O devices 508a-b may be coupled to data processing system 500 directly or indirectly through intervening I/O controllers (not shown).

In the embodiment, a network adapter 510 is coupled to data processing system 500 to enable data processing system 500 to become coupled to other data processing systems or remote printers or storage devices through communication link 512. Communication link 512 can be a private or public network. Modems, cable modems, and Ethernet cards are just a few of the currently available types of network adapters.

Various implementations for dynamic statement processing in database systems have been described. Nevertheless, one of ordinary skill in the art will readily recognize that various modifications may be made to the implementations, and any variations would be within the spirit and scope of the present invention. For example, the above-described process flows are described with reference to a particular ordering of process actions. However, the ordering of many of the described process actions may be changed without affecting the scope or operation of the invention. Accordingly, many modifications may be made by one of ordinary skill in the art without departing from the spirit and scope of the following claims.

What is claimed is:

1. A method for processing dynamic statements in a database system, the method comprising:
calculating a first set of characteristics associated with a dynamic statement when the dynamic statement matches one of a plurality of dynamic statements previously processed by the database system;
comparing the first set of characteristics associated with the dynamic statement to a second set of characteristics associated with one of one or more access paths generated for the one previously processed dynamic statement; and
utilizing the one access path generated for the one previously processed dynamic statement to execute the dynamic statement when the comparison of the first set of characteristics to the second set of characteristics satisfies one or more predetermined criteria.

2. The method of claim 1, further comprising:
distilling the dynamic statement into a base statement; and
determining whether the base statement matches a cached base statement corresponding to one of the plurality of previously processed dynamic statements.

3. The method of claim 1, wherein the first set of characteristics comprises one or more of an overall filtering associated with each of one or more tables referenced by one or more predicates in the dynamic statement and a filtering and cost associated with each of one or more indexes for the one or more tables referenced by the one or more predicates in the dynamic statement.

4. The method of claim 1, wherein the second set of characteristics comprises one or more of an overall filtering associated with a leading table used by the one access path and a filtering and cost associated with each of one or more indexes used by the one access path.

5. The method of claim 1, wherein the one or more predetermined criteria comprises one or more of:
a first criterion requiring a leading table used by the one access path to provide filtering that is better than or within a first predetermined range of filtering provided by each of one or more alternative leading tables;
a second criterion requiring each of one or more indexes used by the one access path to provide filtering that is better than or within a second predetermined range of filtering provided by each of one or more alternative indexes; and
a third criterion requiring each of the one or more indexes used by the one access path to have an associated cost that is less than or within a third predetermined range of a cost associated with each of the one or more alternative indexes.

6. The method of claim 1, wherein the first set of characteristics and the second set of characteristics are calculated based on one or more statistics collected for the one previously processed dynamic statement and stored in the database system.

7. A system for processing dynamic statements, the system comprising:
at least one database; and
a first module coupled to the at least one database, the first module being operable to:
calculate a first set of characteristics associated with a dynamic statement when the dynamic statement matches one of a plurality of dynamic statements previously processed by the system,
compare the first set of characteristics associated with the dynamic statement to a second set of characteristics associated with one of one or more access paths generated for the one previously processed dynamic statement, and
utilize the one access path generated for the one previously processed dynamic statement to execute the dynamic statement when the comparison of the first set of characteristics to the second set of characteristics satisfies one or more predetermined criteria.

8. The system of claim 7, further comprising:
a second module coupled to the at least one database and the first module, the second module being operable to:
distill the dynamic statement into a base statement, and
determine whether the base statement matches a cached base statement corresponding to one of the plurality of previously processed dynamic statements.

9. The system of claim 8, wherein the first module and the second module are part of one module.

10. The system of claim 7, wherein the first set of characteristics comprises one or more of an overall filtering associated with each of one or more tables referenced by one or more predicates in the dynamic statement and a filtering and cost associated with each of one or more indexes for the one or more tables referenced by the one or more predicates in the dynamic statement.

11. The system of claim 7, wherein the second set of characteristics comprises one or more of an overall filtering associated with a leading table used by the one access path and a filtering and cost associated with each of one or more indexes used by the one access path.

12. The system of claim 7, wherein the one or more predetermined criteria comprises one or more of:
a first criterion requiring a leading table used by the one access path to provide filtering that is better than or within a first predetermined range of filtering provided by each of one or more alternative leading tables;
a second criterion requiring each of one or more indexes used by the one access path to provide filtering that is better than or within a second predetermined range of filtering provided by each of one or more alternative indexes; and
a third criterion requiring each of the one or more indexes used by the one access path to have an associated cost that is less than or within a third predetermined range of a cost associated with each of the one or more alternative indexes.

13. The system of claim 7, wherein the first set of characteristics and the second set of characteristics are calculated based on one or more statistics collected for the one previously processed dynamic statement and stored in the at least one database.

14. The system of claim 7, wherein the plurality of previously processed dynamic statements and the one or more access paths generated for each of the plurality of previously processed dynamic statements are stored in a dynamic statement cache in the at least one database.

15. A computer program product comprising a computer readable medium, the computer readable medium including a computer readable program for processing dynamic statements in a database system, wherein the computer readable program when executed on a computer causes the computer to:
calculate a first set of characteristics associated with a dynamic statement when the dynamic statement matches one of a plurality of dynamic statements previously processed by the database system;
compare the first set of characteristics associated with the dynamic statement to a second set of characteristics associated with one of one or more access paths generated for the one previously processed dynamic statement; and
utilize the one access path generated for the one previously processed dynamic statement to execute the dynamic statement when the comparison of the first set of characteristics to the second set of characteristics satisfies one or more predetermined criteria.

16. The computer program product of claim 15, wherein the computer readable program when executed on the computer further causes the computer to:
distill the dynamic statement into a base statement; and
determine whether the base statement matches a cached base statement corresponding to one of the plurality of previously processed dynamic statements.

17. The computer program product of claim 15, wherein the first set of characteristics comprises one or more of an overall filtering associated with each of one or more tables referenced by one or more predicates in the dynamic statement and a filtering and cost associated with each of one or more indexes for the one or more tables referenced by the one or more predicates in the dynamic statement.

18. The computer program product of claim 15, wherein the second set of characteristics comprises one or more of an overall filtering associated with a leading table used by the one access path and a filtering and cost associated with each of one or more indexes used by the one access path.

19. The computer program product of claim 15, wherein the one or more predetermined criteria comprises one or more of:
a first criterion requiring a leading table used by the one access path to provide filtering that is better than or within a first predetermined range of filtering provided by each of one or more alternative leading tables;
a second criterion requiring each of one or more indexes used by the one access path to provide filtering that is better than or within a second predetermined range of filtering provided by each of one or more alternative indexes; and
a third criterion requiring each of the one or more indexes used by the one access path to have an associated cost that is less than or within a third predetermined range of a cost associated with each of the one or more alternative indexes.

20. The computer program product of claim 15, wherein the first set of characteristics and the second set of characteristics are calculated based on one or more statistics collected for the one previously processed dynamic statement and stored in the database system.
